(19) United States
(12) Patent Application Publication
(10) Pub. No.: US 2024/0393547 A1
(43) Pub. Date: Nov. 28, 2024

(54) CONNECTOR ASSEMBLY AND ENCLOSURE FOR CONNECTING OPTICAL FIBERS

(71) Applicant: AFL IG LLC, Duncan, SC (US)

(72) Inventors: Tommy Fritz, Johannesburg (ZA); Conrad Eksteen, Johannesburg (ZA); Alastair Pickburn, Lymington (UG); Aran Davidson, Milton Keynes (GB)

(21) Appl. No.: 18/694,074

(22) PCT Filed: Sep. 21, 2022
(86) PCT No.: PCT/US2022/044226

§ 371 Date: Mar. 21, 2024

Related U.S. Application Data
(60) Provisional application No. 63/246,775, filed on Sep. 21, 2021.

(51) Int. Cl. G02B 6/38; G02B 6/44

(52) U.S. Cl. CPC G02B 6/3879; G02B 6/3849; G02B 6/3891; G02B 6/4446

(57) ABSTRACT

Systems and methods for connecting cables in telecommunication systems are provided. A connector assembly for a telecommunication system includes a shroud, an alignment collar, and a latch actuator coupled to the shroud. The shroud forms and an outer body configured to dispose around an optical cable. The alignment collar includes an arcuate sector and a collar wall extending into the slot at the shroud. The alignment collar includes a receiving area configured to receive a telecommunications connector. The alignment collar is configured to move within the slot at the shroud as the shroud is rotated. The latch actuator is coupled to the shroud and includes a latch cam. The latch cam is configured to bias a latch at the telecommunications connector to an unlock position when the latch actuator is rotated by the shroud.

### PRIORITY STATEMENT

The present application claims the benefit of priority to U.S. Provisional patent Application Ser. No. 63/246,775, filed on Sep. 21, 2021, the disclosure of which is incorporated by reference herein in its entirety.

### FIELD

The present invention relates to telecommunication systems, and more particularly, to fiber optic connectors.

### BACKGROUND

Telecommunication systems typically utilize optical fibers to transmit data between two or more locations using the optical fibers. In view of design limitations, it is necessary to incorporate connection points along the optical fiber runs. It is important at these connection points (and in general) to minimize optical fiber loss and protect exposed portions of the delicate optical fibers from damage. Accordingly, systems and methods for protecting and connecting telecommunications connectors, such as optical fiber connectors, would be advantageous.

### BRIEF DESCRIPTION

Aspects and advantages of the invention will be set forth in part in the following description, or may be understood from the description, or may be learned through practice of the invention.

An aspect of the present disclosure is directed to a connector assembly for a telecommunication system. The connector assembly includes a shroud, an alignment collar, and a latch actuator coupled to the shroud. The shroud forms and an outer body configured to dispose around an optical cable. The alignment collar includes an arcuate sector and a collar wall extending into the slot at the shroud. The alignment collar includes a receiving area configured to receive a telecommunications connector. The alignment collar is configured to move within the slot at the shroud as the shroud is rotated. The latch actuator is coupled to the shroud and includes a latch cam. The latch cam is configured to bias a latch at the telecommunications connector to an unlock position when the latch actuator is rotated by the shroud.

Another aspect of the present disclosure is directed to a connector assembly for a telecommunication system, the connector assembly including a first connector including a first latch forming a release mechanism. The first connector is configured to receive an optical cable. A first shroud forms an outer body configured to dispose around the optical cable. The first shroud forms a slot extending substantially along a circumferential direction along an interior wall of the first shroud. An alignment collar includes an arcuate sector in which a collar wall extends into the slot at the first shroud. The alignment collar forms a receiving area configured to receive the latch at the connector. The alignment collar is configured to move within the slot at the first shroud as the first shroud rotates. A latch actuator is coupled to the first shroud and includes a latch cam configured to bias the latch at the connector to an unlock position when the latch actuator is rotated by the first shroud.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates an exemplary embodiment of a telecommunication enclosure in accordance with aspects of the present disclosure;

FIG. 2 illustrates an exemplary embodiment of a connector assembly in accordance with aspects of the present disclosure;

FIG. 3 illustrates a cross-sectional view of an exemplary embodiment of a connector assembly in accordance with aspects of the present disclosure;

FIG. 4 illustrates a partially transparent perspective view of a portion of an exemplary embodiment of a connector assembly in accordance with aspects of the present disclosure;

FIG. 5 illustrates a perspective view of a portion of an exemplary embodiment of a connector assembly in accordance with aspects of the present disclosure;

FIG. 6 illustrates a view of a portion of an exemplary embodiment of a connector assembly in accordance with aspects of the present disclosure; and

FIG. 7 illustrates a partially transparent perspective view of an exemplary embodiment of the connector assembly in accordance with aspects of the present disclosure;

FIG. 8 illustrates a partially transparent perspective view of a portion of an exemplary embodiment of a connector assembly in accordance with aspects of the present disclosure.

Repeat use of reference characters in the present specification and drawings is intended to represent the same or analogous features or elements of the present invention.

### DETAILED DESCRIPTION

Reference now will be made in detail to embodiments of the present invention, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Approximating language, as used herein throughout the specification and claims, is applied to modify any quantitative representation that could permissibly vary without resulting in a change in the basic function to which it is related. Accordingly, a value modified by a term or terms, such as “about,” “generally,” “approximately,” and “substantially,” are not to be limited to the precise value specified. In at least some instances, the approximating language may correspond to the precision of an instrument for measuring the value, or the precision of the methods or machines for constructing or manufacturing the components or systems. For example, the approximating language may refer to being within a ±10 percent margin. When used in the context of an angle or direction, such terms include within ten degrees greater or less than the stated angle or direction. For example, “generally vertical” includes directions within ten degrees of vertical in any direction, e.g., clockwise or counterclockwise.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

In general, embodiments in accordance with the present disclosure are configured to protect and connect optical fibers. In particular, embodiments described herein may be directed to ruggedized connectors which include ruggedized components configured to provide enhanced protection to the optical fibers.

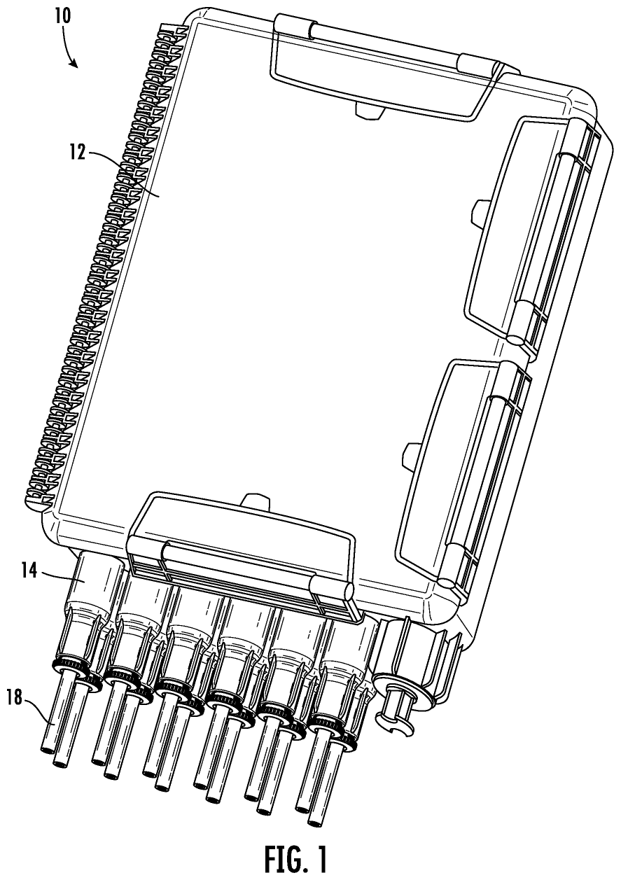

FIG. 1 illustrates an exemplary embodiment of a telecommunication enclosure 10 including a housing 12 having ports configured to receive one or more connector assemblies 14. By way of non-limiting example, the housing 12 may receive at least two connector assemblies 14, such as at least three connector assemblies 14, such as at least five connector assemblies 14, such as at least ten connector assemblies 14. The connector assembly 14 can be removably connected to the housing 12. Each connector assembly 14 can house a portion of an optical cable 16 and define a connection point for the optical cable 16 to the housing 12. By way of exemplary embodiment, the telecommunication enclosure 10 may include one or more components of optical fiber equipment, such as routers, splitters, splices, or the like.

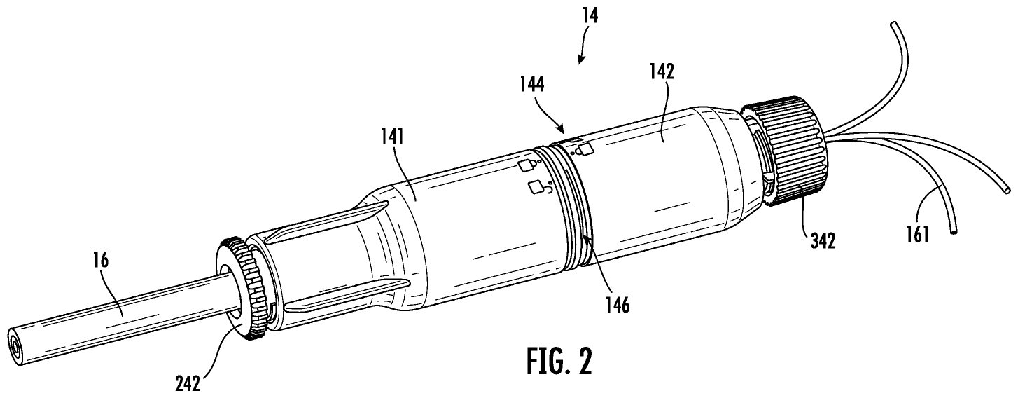

FIG. 2 illustrates an exemplary embodiment of a connector assembly 14 in accordance with embodiments of the present disclosure. The connector assembly 14 can generally include a first connector 141 and a second connector 142. The first connector 141 can be a ruggedized connector. The first connector 141 configured as a ruggedized connector can be configured to be exposed to harsh environments, such as at exterior locations, or generally Outside Plant (OSP) conditions, that may include fresh or salt water, heat, humidity, particulates, or combinations thereof. The second connector 142 can include a non-ruggedized connector or a ruggedized connector. The second connector 142 may be disposed within the housing 12. A bulkhead 146 can be disposed between the first connector 141 and second connector 142. In some embodiments, the bulkhead 146 is integral to the housing 12. In still some embodiments, the bulkhead 146 is separable from the housing 12.

The optical cable 16 entering the first connector 141 can be in optical communication with one or more optical fibers 161. The optical fibers may be connected to the bulkhead 146 through the second connector 142. The optical cable 16 may include any one or more of sheathes, outer jackets, strength members, buffer tubes, wraps, or other structures generally understood for telecommunications cables, such as optical fiber cables, such as optical cables including a plurality of optical fibers.

As shown in FIG. 2, the first connector 141 and the second connector 142 can include indicia 144 informing an operator of a relative configuration of the first connector 141 or the second connector 142 with respect to the bulkhead 146. The depicted indicia 144 include illustrations for a locked position and an unlocked position. Referring to the indicia 144 of the first connector 141, when the first connector 141 is locked, a lock depicted in a locked condition can align with an alignment feature, or be disposed at a particular orientation, to signal to the operator that the first connector 141 is locked to the bulkhead 146, i.e., the first connector 141 is positively secured therewith. When the first connector 141 is rotated counterclockwise, an unlocked lock can align with the alignment feature, or be disposed at the particular orientation, to signal to the operator that the first connector 141 is unlocked from the bulkhead 146, i.e., the first connector 141 is free to be disengaged therefrom. Upon unlocking the first connector 141, e.g., by twisting the first connector 141 in the counterclockwise direction, the operator may pull the first connector 141 from the bulkhead 146 so as to disengage the optical cable 16 therefrom.

Conversely, to fasten the first connector 141 to the bulkhead 146, the operator can first install the first connector 141 within the bulkhead 146 by pushing the first connector 141 into the bulkhead 146. After the first connector 141 is relatively aligned with the bulkhead 146, the operator can rotate the first connector 141 in the clockwise direction until the lock aligns with the alignment feature. At such time, the first connector 141 may be positively secured with the bulkhead 146.

The second connector 142 may operate in a similar manner with respect to the bulkhead 146. That is, the second connector 142 may be rotated in a clockwise direction to positively secure with the bulkhead 146 and rotated in a counterclockwise direction to unlock the second connector 142 and allow the operator to pull the second connector 142 from the bulkhead 146. Other operational protocols are contemplated herein along with different rotational orientations for locking and unlocking the first or second connectors 141, 142. For instance, clockwise rotations described herein may be counter-clockwise rotations, and counter-clockwise rotations described herein may be clockwise rotations.

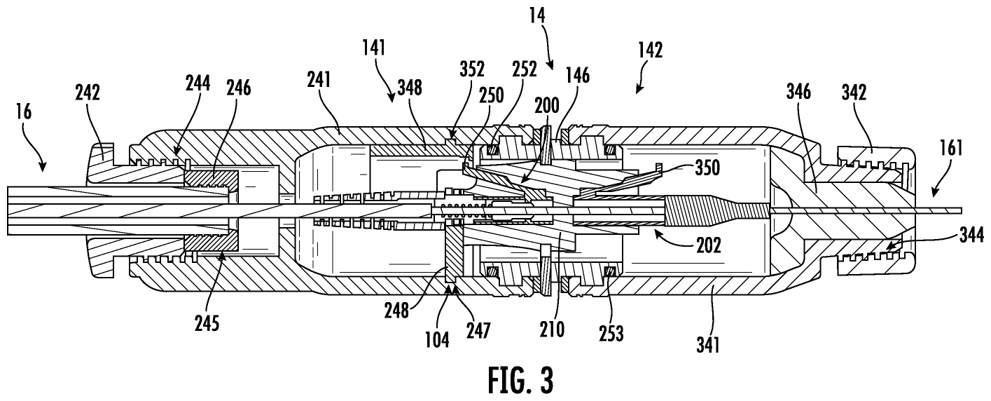

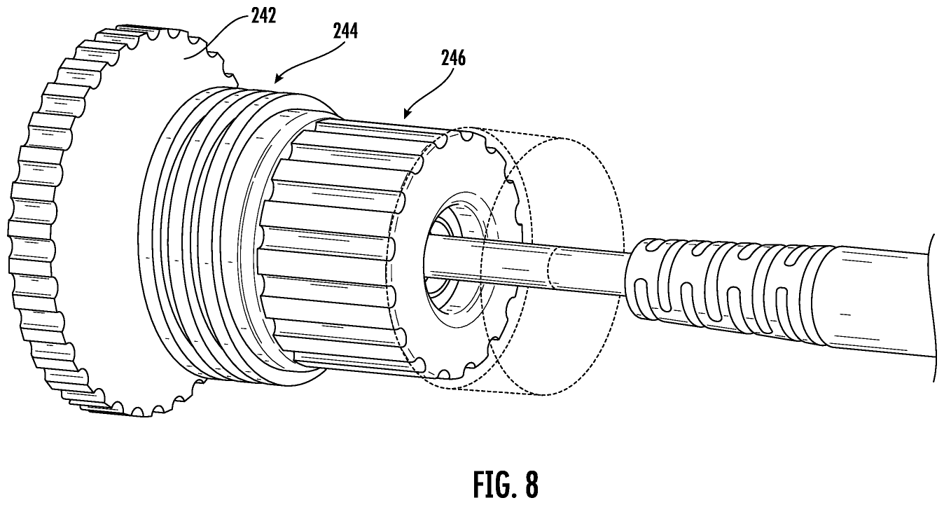

FIG. 3 illustrates a cross-sectional view of the connector assembly 14 depicted in FIG. 2. The first connector 141 includes a first shroud 241 forming an outer body configured to be disposed around and protect the optical cable 16. The shroud 241 can be coupled to the optical cable 16 through a first fitting 242. The fitting 242 may form a cable fitting extending into the shroud 241, such as further depicted in the partially transparent perspective view illustrated in FIG. 8. By way of non-limiting example, the fitting 242 may be releasably engaged with the shroud 241 at an attachment interface 244. The attachment interface 244 may form a threaded interface at which the shroud 241 and the cabling fitting 242 couple. As the fitting 242 is threaded to the shroud 241, the fitting 242 may compress into the optical cable 16 so as to form a compression fit therebetween. In certain instances, the compression fit between the fitting 242 and optical cable 16 can be ruggedized, e.g., waterproof and contaminant resistant, such that an interior of the housing 12 is protected from weather, debris, particulate matter, fluid, insects, or other contaminants which might otherwise enter the housing 12, or additionally, damage optical fibers, optical fiber connections, or optical fiber equipment disposed in the housing 12. In an embodiment, the first connector 141 can define a receiving area 245, such as a wall or cavity within the first connector 141. The receiving area 245 is configured to receive a seal 246. The seal 246 may form a cable seal configured to seal the optical cable 16 to the first connector 141 to prevent ingress of contaminants into the housing 12.

As described in greater detail herein, the shroud 241 may include a groove or slot 247 into which an alignment collar 248 is disposed. The shroud 241 may form the slot 247 as a groove or recess extending substantially along a circumferential direction along an interior wall or surface of the shroud 241, e.g., an interior surface forming a volume at which the first fiber optic connector 200 is disposed. The alignment collar 248 may interface with a first latch 250 at a first fiber optic connector 200. The first latch 250 may include a lever, clip, or other release mechanism at the first fiber optic connector 200 configured to release the first fiber optic connector 200 from the adapter 210. A first seal 252 (e.g., O-ring, rope seal, sealant material, putty, epoxy, etc.) can be disposed at a location along the first connector 141 so as to interface with any one or more of the shroud 241, the alignment collar 248, an internal member, or a surface of the bulkhead 146. A second seal 253 (e.g., O-ring, rope seal, sealant material, putty, epoxy, etc.) can be disposed at a location along the second connector 142 so as to interface with any one or more of a second shroud 341 covering the second connector 142, an internal member, or a surface of the bulkhead 146.

The second connector 142 can further include a second fitting 342 extending around the one or more optical fibers 161 within the second connector 142. The second fitting 342 may form a compression fitting configured to compress around an internal seal 346. The seal 346 can be disposed between the one or more optical fibers 161 and the fitting 342. The internal seal 346 and fitting 342 can provide a contaminant resistant interface to further prevent ingress of debris into the housing 12 or from the housing 12 into the connector assembly 14.

Referring still to FIG. 3, a coupler or adapter 210 is configured to operably connect the optical cable 16 and the optical fibers 161. The adapter 210 may be configured to operably couple the first fiber optic connector 200 at the first connector 141 to a second fiber optic connector 202 at the second connector 142. The second fiber optic connector 202 may include a second latch 350 configured at the second fiber optic connector 202 substantially similarly as described regarding the first latch 250 at the first fiber optic connector 200. In certain instances, the adapter 210 can be an LC adapter and the connectors 200, 202 can be LC connectors. In other embodiments, the adapter 210 is any appropriate type of coupler or adapter with a push-down latch, lever, or other release mechanism. In various embodiments, the adapter 210 can be coupled to the bulkhead 146. In still various embodiments, the adapter 210 may float, such as to be disconnected from the bulkhead 146 but retained therein such that movement is permitted between the bulkhead 146 and the adapter 210.

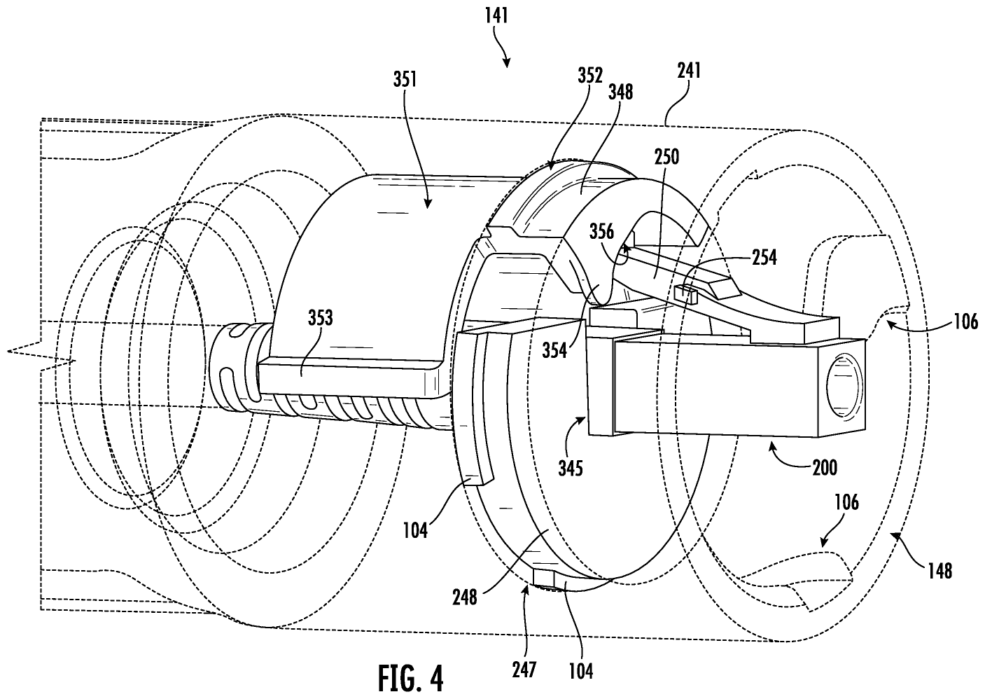

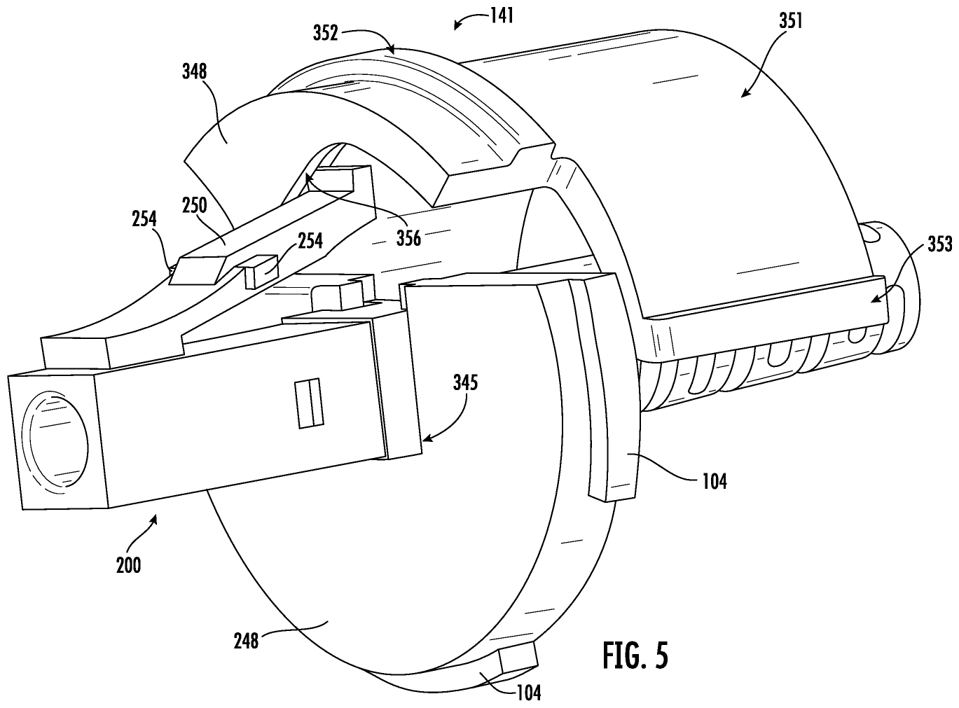

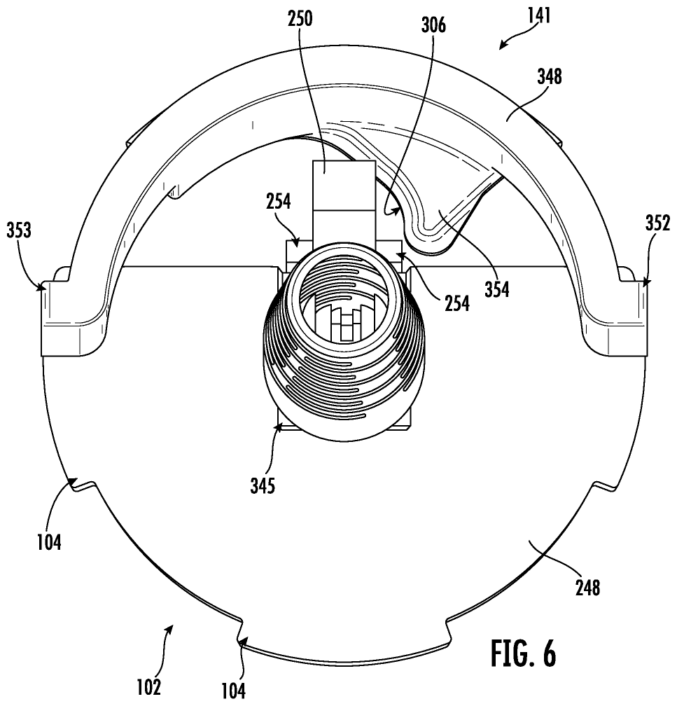

FIG. 4 depicts illustrates a partially transparent, perspective view of the first connector 141 in accordance with an exemplary embodiment. FIG. 5 depicts a perspective view of a portion of the first connector 141 in accordance with an exemplary embodiment. FIG. 6 illustrates a view of an embodiment of the alignment collar 248 and latch actuator 348 in accordance with an exemplary embodiment. Referring to FIGS. 4-6, the first connector 141 includes a slot 247 in which a feature, protrusion, or collar wall 104 of the alignment collar 248 is disposed. In some embodiments, the slot 247 extends along a circumferential direction at an interior wall of the first connector 141. In still some embodiments, the wall 104 extends radially outward and along an arcuate portion of a body forming the alignment collar 248. The body forming the alignment collar 248 may form an arcuate sector, a partial circular body, or a partial cylindrical body. For instance, the body forming the alignment collar 248 may include a partial or semi-circular cross section (e.g., an arcuate sector, a chord-cut circle, etc.) or an arcuate body having a plane extending a length (e.g., a length co-directional to an extension of the optical cable 16). A slot or groove 102 may be formed between circumferentially adjacent walls 104. Accordingly, walls 104 may be circumferentially separated and spaced apart by arcuate slots 102.

The alignment collar 248 can be rotatable relative to the shroud 241, e.g., within the slot 247. The alignment collar 248 can include a receiving area 345 configured to receive the first latch 250. The receiving area 345 may include an opening, a hole, a slot, or notch extending into the body forming the alignment collar 248. For instance, the receiving area 345 may form an opening extending from a chord-cut plane of the body forming the alignment collar 248. The receiving area 345 may be configured to receive at least a portion of the first fiber optic connector 200. As the shroud 241 rotates between the locked and unlocked configurations, the alignment collar 248 can move within the slot 247 such that the receiving area 345 of the alignment collar 248 remains aligned with the first latch 250. In this regard, the alignment collar 248 can maintain the first latch 250 at a relatively fixed angular orientation with respect to the bulkhead 146 during rotation of the shroud 241.

Referring still to FIGS. 4-6, the first connector 141 includes a latch actuator 348 including a feature, protrusion, or actuator wall 352 disposed within the same or another slot 247. In some embodiments, such as depicted in FIGS. 4-6, the wall 352 of the latch actuator 348 is disposed within the same slot 247 as the feature 104 of the alignment collar 248. A body forming the latch actuator 348 may form an arcuate sector, a partial circular body, or a partial cylindrical body. The latch actuator 348 may form a separate component from the alignment collar 248, such that the latch actuator 348 and the alignment collar 248 may be separately articulatable. The wall 352 may extend radially outward from the body such as described in regard to wall 104.

The latch actuator 348 can include wall 353 forming an anti-rotation feature. The wall 353 may extend substantially along a length (e.g., co-directional to an extension of the optical cable 16 into the connector assembly 14). In this regard, the latch actuator 348 can be relatively fixed to the shroud 241, directly or indirectly, such that when the shroud 241 is rotated, the latch actuator 348 similarly rotates. In some embodiments, the latch actuator 348 may be integral with the shroud 241. In still some embodiments, the latch actuator 348 may include an arcuate wall 351 extending along a length. The wall 353 forming the anti-rotation wall may form a longitudinally extended wall extending at least partially along the length of the arcuate wall 351.

The latch actuator 348 can include a latch cam 354. The latch cam 354 can be in operational communication with the first latch 250. When the latch actuator 348 is rotated (e.g., by rotation of the shroud 241), the latch cam 354 can bias the first latch 250 (e.g., compress the first latch 250) so as to unlock a locking element 254 of the first latch 250 from the adapter 210 (FIG. 3) and allow the first latch 250 to be disengaged from the adapter 210. The latch cam 354 can have a ramp 356 with a shape and size such that the first latch 250 is gradually depressed during rotation of the shroud 241.

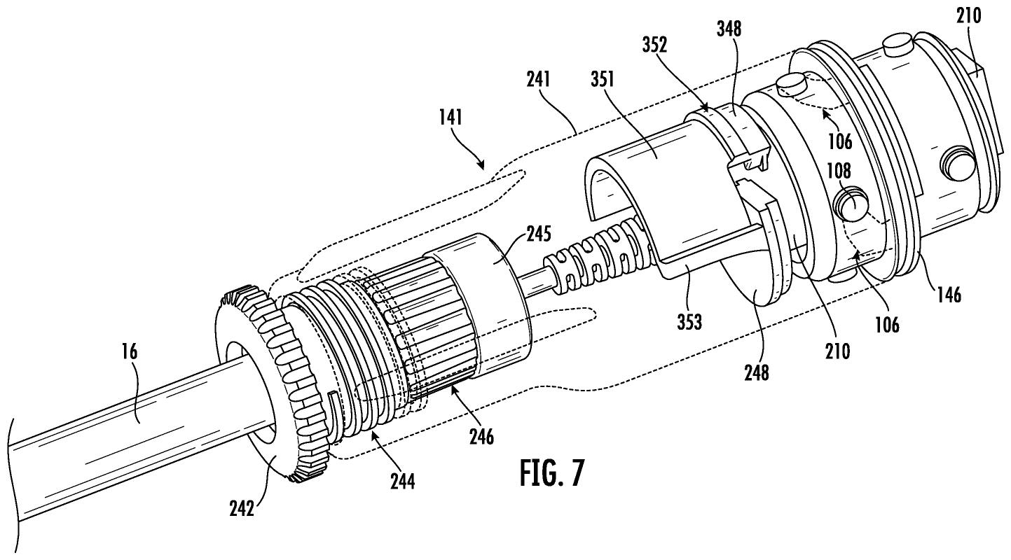

Referring now to FIG. 7, a partially transparent perspective view of an embodiment of the connector assembly 14 is provided. Rotation of the shroud 241 may be confined by one or more bayonet slots 106 disposed in the shroud 241. For instance, rotation of the shroud 241 may be confined by one or more bayonet slots 106 disposed in the shroud 241 while a bulkhead interface 148 of the shroud 241 is in communication with the bulkhead 146. The latch cam 354 can be shaped such that the amount of angular displacement of the bayonet projections 108 within the bayonet slots 106 is sufficient to rotate the latch cam 354 relative to the first latch 250. In some embodiments, the latch cam 354 can be shaped such that the amount of angular displacement of the bayonet projections 108 within the bayonet slots 106 is sufficient to rotate the latch cam 354 relative to the first latch 250 a sufficient amount so as to depress the first latch 250. In still some embodiments, the latch cam 354 can be shaped such that the amount of angular displacement of the bayonet projections 108 within the bayonet slots 106 is sufficient to rotate the latch cam 354 relative to the first latch 250 a sufficient amount so as to depress the first latch 250 by a sufficient amount to unlock the locking element 254 from the adapter 210 and permit removal or installation of the first connector 141 relative to the bulkhead 146. This may be referred to as single-action connection and disconnection.

In one or more embodiments, the connector assembly 14 can have an outer diameter of approximately 30 millimeters (mm) or less, such as approximately 28 mm or less, such as approximately 26 mm or less, such as approximately 25 mm or less, as measured at the largest diameter thereof. A connection density of connector assemblies 14 at the housing 12 can be greater than 0.25 connector assemblies per square inch, such as greater than 0.5 connector assemblies per square inch, such as greater than 0.75 connector assemblies per square inch, such as greater than one connector assembly per square inch. In some embodiments, the bulkhead 146 may be an integral piece of the housing 12. In other embodiments, the bulkhead 146 may include a discrete element in communication with the bulkhead 146. In some instances, the connector assemblies 14 engaged with a housing 12 may all be generally fungible with one another. In other instances, connector assemblies 14 having different sizes or shapes may be used in conjunction with one another at the same enclosure 10.

Embodiments of systems and methods for connecting optical fibers such as provided herein may allow for single-action connection and disconnection of optical fiber cables to fiber optic connectors and telecommunication enclosures. Embodiments provided herein may mitigate fluid communication, particulate matter, humidity, dust, or other undesired matter or debris into interior portions of the connector, to the optical fiber, into the enclosure, or other operable portions of the connector and telecommunication enclosure. Embodiments provided herein may further, or alternatively, improve connection and disconnection of fiber optic cables, including quicker installation and de-installation time, lower costs, reduced damage and replacement, or improved durability.

Further aspects of the invention are provided by the subject matter of the following clauses:

1. A connector assembly for a telecommunication system, the connector includes a shroud, an alignment collar, and a latch actuator coupled to the shroud. The shroud forms and an outer body configured to dispose around an optical cable. The alignment collar includes an arcuate sector and a collar wall extending into the slot at the shroud. The alignment collar includes a receiving area configured to receive a telecommunications connector. The alignment collar is configured to move within the slot at the shroud as the shroud is rotated. The latch actuator is coupled to the shroud and includes a latch cam. The latch cam is configured to bias a latch at the telecommunications connector to an unlock position when the latch actuator is rotated by the shroud.

2. The connector assembly of any one or more clauses herein, wherein the latch cam forms a ramp, and wherein the ramp at the latch cam is configured to gradually depress the latch at the telecommunications connector when the shroud is rotated.

3. The connector assembly of any one or more clauses herein, wherein the alignment collar and the latch actuator form separate components from one another.

4. The connector assembly of any one or more clauses herein, wherein the latch actuator and the shroud form separate components from one another.

5. The connector assembly of any one or more clauses herein, the latch actuator including an anti-rotation wall configured to fix the latch actuator relative to the shroud as the shroud is rotated.

6. The connector assembly of any one or more clauses herein, the latch actuator includes an actuator wall extending into the slot at the shroud.

7. The connector assembly of any one or more clauses herein, the shroud forming a bayonet slot, wherein an angular extension of the bayonet slot corresponds to the latch cam relative to the latch cam depressing the latch at the telecommunications connector when the shroud is rotated.

8. A connector assembly for a telecommunication system, the connector assembly including a first shroud forming an outer body configured to dispose around the optical cable, the first shroud forming a slot extending substantially along a circumferential direction along an interior wall of the first shroud; an alignment collar including an arcuate sector and a collar wall, wherein the collar wall extends into the slot at the first shroud, and wherein the alignment collar includes a receiving area configured to receive a first fiber optic connector at which an optical cable is received, wherein the alignment collar is configured to move within the slot at the first shroud as the first shroud is rotated; and a latch actuator coupled to the first shroud, the latch actuator including a latch cam configured to bias a latch at the fiber optic connector to an unlock position when the latch actuator is rotated by the shroud.

9. The connector assembly of any one or more clauses herein, wherein the latch cam forms a ramp at which the latch is gradually depressed during rotation of the shroud.

10. The connector assembly of any one or more clauses herein, wherein the alignment collar and the latch actuator form separate components from one another.

11. The connector assembly of any one or more clauses herein, the latch actuator including an anti-rotation wall extending substantially co-directional to an extension of the optical cable into the connector assembly, wherein the anti-rotation wall is configured to fix the latch actuator relative to the shroud as the first shroud is rotated.

12. The connector assembly of any one or more clauses herein, the latch actuator includes an actuator wall extending into the slot at the first shroud.

13. The connector assembly of any one or more clauses herein, wherein the actuator wall and the collar wall each extend radially outward into the slot at the first shroud.

14. The connector assembly of any one or more clauses herein, wherein the actuator wall and the collar wall each extend into the same slot at the first shroud.

15. The connector assembly of any one or more clauses herein, wherein an opening is formed along a direction of rotation between the latch actuator and the alignment collar.

16. The connector assembly of any one or more clauses herein, including the first fiber optic connector configured to receive the optical cable, wherein the first shroud is configured to dispose around the first fiber optic connector; a second fiber optic connector configured to output one or more optical fibers; a second shroud configured to dispose around the second fiber optic connector; and a fiber optic coupler configured to operably couple the first fiber optic connector and the second fiber optic connector.

17. The connector assembly of any one or more clauses herein, including a bulkhead disposed between the first fiber optic connector and a second fiber optic connector.

18. The connector assembly of any one or more clauses herein, the first shroud forming a bayonet slot, wherein an angular extension of the bayonet slot corresponds to the latch cam relative to the latch cam depressing the latch at a first fiber optic connector when the first shroud is rotated.

19. An enclosure for a telecommunication system, the enclosure including a housing forming ports configured to receive one or more connector assemblies of any one or more clauses herein.

20. The enclosure of any one or more clauses herein, the enclosure including a connection density of connector assemblies at the housing greater than 0.25 connector assemblies per square inch.

21. A method for connecting and disconnecting fiber optic connectors in accordance with any one or more clauses herein.

22. The method of any one or more clauses herein, the method including a single-action connection or disconnection of a first connector and a second connector.

23. The method of any one or more clauses herein, the method including attaching a latch cam to a shroud surrounding a first connector; rotating the shroud and latch cam together to depress the latch cam onto a latch at the first connector to permit removal or installation of the first connector relative to a bulkhead.

24. The method of any one or more clauses herein, the method including maintaining, at an alignment collar, the first connector stationary relative to rotation of the shroud surrounding the first connector.

25. The method of any one or more clauses herein, the method including rotating the shroud surrounding the first connector; and allowing an alignment collar to move within a slot formed at the shroud when the shroud is rotated.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

1. A connector assembly for a telecommunication system, the connector assembly comprising:
a shroud forming an outer body configured to dispose around an optical cable, the shroud forming a slot;
an alignment collar forming an arcuate sector, the alignment collar comprising a collar wall extending into the slot at the shroud, wherein the alignment collar forms a receiving area configured to receive a telecommunications connector, and wherein the alignment collar is configured to move within the slot at the shroud as the shroud is rotated; and
a latch actuator coupled to the shroud, the latch actuator comprising a latch cam, wherein the latch cam is configured to bias a latch at the telecommunications connector to an unlock position when the latch actuator is rotated by the shroud.

2. The connector assembly of claim 1, wherein the latch cam forms a ramp, wherein the ramp at the latch cam is configured to gradually depress the latch at the telecommunications connector when the shroud is rotated.

3. The connector assembly of claim 1, wherein the alignment collar and the latch actuator form separate components from one another.

4. The connector assembly of claim 3, wherein the latch actuator and the shroud form separate components from one another.

5. The connector assembly of claim 4, the latch actuator comprising an anti-rotation wall configured to fix the latch actuator relative to the shroud as the shroud is rotated.

6. The connector assembly of claim 1, the latch actuator comprises an actuator wall extending into the slot at the shroud.

7. The connector assembly of claim 1, the shroud forming a bayonet slot, wherein an angular extension of the bayonet slot corresponds to the latch cam relative to the latch cam depressing the latch at the telecommunications connector when the shroud is rotated.

8. A connector assembly for a telecommunication system, the connector assembly comprising:
a first shroud forming an outer body configured to dispose around the optical cable, the first shroud forming a slot extending substantially along a circumferential direction along an interior wall of the first shroud;
an alignment collar comprising an arcuate sector and a collar wall, wherein the collar wall extends into the slot at the first shroud, and wherein the alignment collar comprises a receiving area configured to receive a first fiber optic connector at which an optical cable is received, wherein the alignment collar is configured to move within the slot at the first shroud as the first shroud is rotated; and
a latch actuator coupled to the first shroud, the latch actuator comprising a latch cam configured to bias a latch at the fiber optic connector to an unlock position when the latch actuator is rotated by the shroud.

9. The connector assembly of claim 8, wherein the latch cam forms a ramp, and wherein the ramp at the latch cam is configured to gradually depress the latch at the fiber optic connector when the first shroud is rotated.

10. The connector assembly of claim 8, wherein the alignment collar and the latch actuator form separate components from one another.

11. The connector assembly of claim 8, the latch actuator comprising an anti-rotation wall extending substantially co-directional to an extension of the optical cable into the connector assembly, wherein the anti-rotation wall is configured to fix the latch actuator relative to the first shroud as the first shroud is rotated.

12. The connector assembly of claim 8, the latch actuator comprises an actuator wall extending into the slot at the first shroud.

13. The connector assembly of claim 12, wherein the actuator wall and the collar wall each extend radially outward into the slot at the first shroud.

14. The connector assembly of claim 13, wherein the actuator wall and the collar wall each extend into the same slot at the first shroud.

15. The connector assembly of claim 8, wherein an opening is formed along a direction of rotation between the latch actuator and the alignment collar.

16. The connector assembly of claim 8, comprising:
the first fiber optic connector configured to receive the optical cable, wherein the first shroud is configured to dispose around the first fiber optic connector;
a second fiber optic connector configured to output one or more optical fibers;
a second shroud configured to dispose around the second fiber optic connector; and
a fiber optic coupler configured to operably couple the first fiber optic connector and the second fiber optic connector.

17. The connector assembly of claim 8, comprising:
a bulkhead disposed between the first fiber optic connector and a second fiber optic connector.

18. The connector assembly of claim 8, the first shroud forming a bayonet slot, wherein an angular extension of the bayonet slot corresponds to the latch cam relative to the latch cam depressing the latch at a first fiber optic connector when the first shroud is rotated.

19. An enclosure for a telecommunication system, the enclosure comprising:
a housing forming ports configured to receive one or more connector assemblies of claim 8.

20. The enclosure of claim 19, the enclosure comprising a connection density of connector assemblies at the housing greater than 0.25 connector assemblies per square inch.
